(19) United States
(12) Patent Application Publication
(10) Pub. No.: US 2024/0358028 A1
(43) Pub. Date: Oct. 31, 2024

(54) POWDERED SUGAR REPLACER

(71) Applicant: PURATOS NV, Groot-Bijgaarden (BE)

(72) Inventors: Geertrui BOSMANS, Berchem (BE); Ingrid VAN HAESENDONCK, Mechelen (BE); Bram PAREYT, Kruisem (BE)

(73) Assignee: PURATOS NV, Groot-Bijgaarden (BE)

(21) Appl. No.: 18/577,526

(22) PCT Filed: Aug. 2, 2022
(86) PCT No.: PCT/EP2022/071720

§ 371 Date: Jan. 8, 2024

(30) Foreign Application Priority Data
Aug. 3, 2021 (BE) BE2021/5618

(51) Int. Cl. A21D 2/18; A21D 2/26; A21D 13/062; A23L 27/30; A23L 29/30

(52) U.S. Cl. CPC A21D 2/181; A21D 2/186; A21D 2/26; A21D 13/062; A23L 27/33; A23L 29/30

(57) ABSTRACT

The present invention provides a powdered sugar replacer comprising one or more modified starch(es), one or more fructan(s), one or more protein product(s), one or more starch product(s), and optionally one or more enzyme(s) and/or one or more reducing agent(s), and methods for obtaining the same. The present invention further provides food products comprising the powdered sugar replacer as taught herein, and methods for obtaining the same.

### FIELD OF THE INVENTION

The present invention relates to the field of food processing. More specifically, the present invention relates to a sugar replacer, more particularly to a clean label sugar replacer, more particularly to a clean label sugar replacer used in cakes. The present invention further relates to sugar reduced cake batters and cakes made thereof and to processes to obtain them.

### BACKGROUND

Cakes typically comprise flour, sugar, eggs and a fat source (margarine, oil, etc.) in different ratios, resulting in a wide variety of different types of cakes. Optional ingredients are e.g. emulsifiers, milk powders, (milk) proteins, hydrocolloids, gums, (native and/or chemically or physically modified) starch, cocoa powder, enzymes or aromas.

Sugar is a major ingredient in cake systems. Besides providing sweetness and increasing shelf-life, it has important technological functionalities. It provides viscosity to the batter, which is essential for air incorporation and gas cell stabilization during mixing and the early stages of baking to obtain cakes with good volume. Next, it impacts the temperatures at which starch gelatinization and protein denaturation occur. This results in postponed starch and protein network formation and, hence, structure setting, leading to prolonged oven rise and eventually to cakes with a fine, uniform and porous crumb structure.

In recent years, more and more attention has been paid to obesity and associated metabolic and cardiovascular diseases. Consumers are worried and governments try to ban sugar by taxes, which puts pressure on the food industry to produce products with lower calorie content and improved nutritional profile.

However, reducing or eliminating the amount of added sugar in a cake recipe without altering its desired properties is far from evident, given the complex functionality of sugar in baked products. To maintain the sweet taste of sugar, very often high intensity sweeteners (HIS) like sucralose, aspartame or steviol glycosides are used. Because of their sweetening power being many times that of sucrose, only very low amounts of these ingredients are needed to provide similar sweetness to the cake product. For that reason, these HIS are often combined with bulking agents, like e.g. polydextrose, that partially take over other sugar functionalities (e.g. by creating viscosity and postponing starch gelatinization) during the preparation of cake. However, currently not all HIS and bulking agents are clean label and some of them can create bowel discomfort when consumed in too high quantities. Based on their increased consciousness regarding food ingredients, and their awareness for what is on the food label, consumers more and more want to avoid foods containing numerous additives. This forces food manufacturers to come up with natural ingredients and their derivatives to produce clean (er) label foods which have product characteristics at least comparable to those of the additives containing reference, and puts an additional layer of complexity to the development of a sugar substitute for baked foods. Furthermore, ingredient aspects such as stability, cost, availability, regulatory approval, dietary restrictions and the case of their use in manufacturing need to be taken into account during product formulation. In the European Union and the European Free Trade Association, the substances used as food additives are included in a list coded with “E-numbers”. In other countries additives are organized in other types of similar lists.

Other ways for sugar reduction are the replacement of (part of the) sugar in bakery products by polyols like sorbitol, glycerol, maltitol, erythritol, by oligo-or polysaccharides like polydextrose or fructo-oligosaccharides or by combinations thereof. Polyols however also have an additive status in Europe and some other countries. Furthermore, their excessive consumption induces laxative effects. Most of the solutions known so far either do not allow to replace the entirety of the sugar in a cake recipe or cannot be used as 1 to 1 replacer of the sugar.

Rare sugars (sugars found in nature in small quantities) have recently gained interest as reduced-calorie sugar replacing ingredient. When produced in commercial quantities, several rare sugars provide not only the sweetness of sugar, but also its bulking and physical behaviour. To date, several rare sugars have been commercialised, including tagatose and, most recently, allulose. The former contains an E number, the latter was granted US Food and Drug Administration (FDA) Generally Recognised as Safe (GRAS) status in 2012. Its Novel Food dossier in EU is still pending.

No satisfactory solutions for a clean label (i.e. E number free) powdered sugar replacer that can be used on a 1:1 weight basis for complete or partial replacement of the added sugars or polyols, with similar functionalities as added sugars during cake making, are currently available. Therefore, there remains a need to develop new powdered sugar replacers.

### SUMMARY OF THE INVENTION

Present inventors surprisingly found that the combination of (i) one or more modified starch(es), (ii) one or more fructan(s), (iii) one or more protein product(s) selected from the group consisting of egg proteins, milk proteins, isolated cereal proteins, oilseed proteins, tuber proteins, root proteins, and legume proteins, (iv) one or more starch product(s) (i.e. any source of unmodified or native starch, i.e.

starch that has kept its original structure as it has in the plant from which it is derived), and (v) optionally one or more enzyme(s) and/or one or more reducing agent(s), functions as a powdered sugar replacer in food products, preferably bakery or patisserie products, such as cakes, while keeping the same or highly similar visual and textural (e.g. volume, hardness, cohesiveness, resilience, springiness and stickiness) properties, as well as the same or highly similar organoleptic properties (e.g. no undesirable aftertaste).

Moreover, the powdered sugar replacer of the present invention allows the preparation of food products, preferably bakery or patisserie products, such as cakes, with the same or a highly similar shelf-life as the original food product (i.e. comprising sweetening agent and no powdered sugar replacer).

Furthermore, the powdered sugar replacer of present invention can be used to either completely, or partly replace sugar, such as to replace between 10.0% (w/w) and 100.0% (w/w) of the sugar in a recipe for sugar-comprising food products, on a 1:1 weight basis. This makes the powdered sugar replacer of present invention easy to use because the recipes for sugar-comprising food products do not need to be specially modified to incorporate the powdered sugar replacer of present invention.

In addition, the powdered sugar replacer of present invention can be used to prepare food products, preferably bakery or patisserie products such as cakes, that comprise less or no added sweetening agent, preferably no added sugars and/or polyols and are therefore healthier (e.g. lower calorie content and improved nutritional profile).

A first aspect provides a powdered sugar replacer comprising:
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% (w/w) of one or more starch product(s), and
optionally one or more enzyme(s) and/or one or more reducing agent(s).

In particular embodiments, the sugar replacer comprises at most 0.010% (w/w) of artificial ingredients and/or synthetic chemicals.

In particular embodiments, the one or more protein product(s) are gel-forming proteins and/or have a protein content of at least 30.0% (w/w dry matter).

A further aspect provides a cake mix or cake premix comprising the powdered sugar replacer as taught herein.

A further aspect provides a dough or batter product comprising the sugar replacer as taught herein or the cake mix or cake premix as taught herein.

In particular embodiments, the dough or batter product further comprises flour, eggs or egg products, and optionally one or more of a leavening agent, fat, and a sweetening agent.

In particular embodiments, the dough or batter product is a cake batter.

In particular embodiments, the cake batter is a cream cake batter comprising
between 15.0 and 30.0% (w/w) of flour,
between 5.0 and 30.0% (w/w) of fat,
between 7.0 and 25.0% (w/w) of eggs or egg products,
between 3.0 and 22.0% (w/w) of one or more modified starch(es),
between 3.0 and 18.0% (w/w) of one or more fructan(s),
between 0.20 and 11.4% (w/w) of one or more protein product(s) selected from the group consisting of egg proteins, milk proteins, isolated cereal proteins, oilseed proteins, tuber proteins, root proteins, and legume proteins,
between 0.20 and 30.0% (w/w) of one or more starch product(s),
optionally one or more enzyme(s) and/or one or more reducing agent(s), and
water up to 100.0% (w/w).

In particular embodiments, the cake batter is a sponge-type cake batter comprising between 7.0 and 30.0% (w/w) of flour
between 10.0 and 45.0% (expressed as weight liquid eggs/w) of eggs or egg products,
between 3.0 and 22.0% (w/w) of one or more modified starch(es),
between 3.0 and 18.0% (w/w) of one or more fructan(s),
between 0.20 and 13.9% (w/w) of one or more protein product(s) selected from the group consisting of egg proteins, milk proteins, isolated cereal proteins, oilseed proteins, tuber proteins, root proteins, and legume proteins,
between 0.20 and 30.0% (w/w) of one or more starch product(s),
optionally one or more enzyme(s) and/or one or more reducing agent(s), and
water up to 100.0% (w/w).

In particular embodiments, the dough or batter product does not comprise a sweetening agent in addition to the powdered sugar replacer.

A further aspect provides a food product comprising the powdered sugar replacer as taught herein or the dough or batter product as taught herein, preferably wherein said food product is a bakery or patisserie product, more preferably wherein said bakery or patisserie product is a cake, even more preferably a cream cake or a sponge-type cake.

A further aspect provides a method of preparing a powdered sugar replacer comprising preparing a mixture of at least
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% (w/w) of one or more starch product(s), and
optionally one or more enzyme(s) and/or one or more reducing agent(s).

A further aspect provides a method for preparing the dough or batter product as taught herein, comprising the steps of adding the powdered sugar replacer as taught herein to flour, eggs or egg products, and optionally one or more of a leavening agent, fat and a sweetening agent.

A further aspect provides a method for preparing a bakery or patisserie product comprising preparing a dough or batter product by mixing the powdered sugar replacer as taught herein to flour, eggs or egg products, and optionally one or more of a leavening agent, fat and a sweetening agent, and baking the dough or batter product, thereby obtaining the bakery or patisserie product.

A further aspect provides the use of a composition comprising:
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% of one or more starch product(s) and
optionally one or more enzyme(s) and/or one or more reducing agent(s)
   as a complete or partial replacement for a sweetening agent.

### DETAILED DESCRIPTION

Before the present method and devices used in the invention are described, it is to be understood that this invention is not limited to particular methods, components, or devices described as such methods, components, and devices may, of course, vary. It is also to be understood that the terminology used herein is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any method and material similar or equivalent to those described herein may be used in practice or testing of the present invention, the preferred methods and materials are now described.

In this specification and the appended claims, the singular forms “a”, “an”, “the” include both the singular and the plural, unless the context clearly indicates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. Where this description refers to a product or process which “comprises” specific features, parts or steps, this refers to the possibility that other features, parts or steps may also be present, but may also refer to embodiments which only contain the listed features, parts or steps. The terms “comprising”, “comprises” and “comprised of” also include the term “consisting of”.

The enumeration of numeric values by means of ranges of figures comprises all values and fractions in these ranges, as well as the cited end points.

The terms “about” and “approximately” as used when referring to a measurable value, such as a parameter, an amount, a time period, and the like, is intended to include variations of +/−10% or less, preferably +/−5% or less, more preferably +/−1% or less, and still more preferably +/−0.1% or less, of and from the specified value, in so far as the variations apply to the invention disclosed herein. It should be understood that the value to which the term “about” or “approximately” refers per se has also been disclosed.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Present inventors surprisingly found that the combination of (i) one or more modified starch(es), (ii) one or more fructan(s), (iii) one or more protein product(s) selected from the group consisting of egg proteins, milk proteins, isolated cereal proteins, oilseed proteins, tuber proteins, root proteins, and legume proteins, (iv) one or more starch product(s) (i.e. any source of unmodified or native starch, i.e. starch that has kept its original structure as it has in the plant from which it is derived), and (v) optionally one or more enzyme(s) and/or one or more reducing agent(s), functions as a powdered sugar replacer in food products, preferably bakery or patisserie products, such as cakes, while demonstrating the same or highly similar complex functionalities as sugar in the food product. For example, present inventors demonstrated that in baked bakery products, such as cake, the powdered sugar replacer of present invention can keep the same or a highly similar volume, hardness, cohesiveness, resilience, springiness and stickiness of the baked bakery or patisserie product.

Furthermore, the powdered sugar replacer of present invention can be used to either completely, or partly replace sugar, such as to replace between 10.0% (w/w) and 100.0% (w/w) of the sugar, on a 1:1 weight basis. This makes the powdered sugar replacer of present invention easy to use because the recipes for sugar-comprising food products do not need to be specially modified to incorporate the powdered sugar replacer of present invention.

Sucrose, glucose and fructose, typical sweetening agents used in the formulation of regular cakes, have a calorie intake of 4 kcal/g, which is similar to that of digestible carbohydrates, compared to 9 kcal/g of fat, 4 kcal/g of protein and 2 kcal/g of fiber. Present inventors found that replacement of (part of) the added sucrose, glucose of fructose in a food application by a lower calorie ingredient like e.g. fiber, can reduce the calorie content of food. In addition, consumption of fibers is linked to multiple health benefits. Replacing (part of) the sugar by fiber therefore brings both a calorie reduction and a health promoting potential. Furthermore, replacing sugars by more slowly digestible components like starches or proteins do not reduce the calorie content of the food, but lower the food's glycaemic index and therefore reduce the negative health impact of sugar. Accordingly, the powdered sugar replacer of present invention can be used to prepare food products, preferably bakery or patisserie products such as cakes, that are healthier (e.g. lower calorie content and improved nutritional profile).

Moreover, the sugar replacer as taught herein is better than known sugar replacers, such as maltitol, as the sugar replacer as taught herein does not lead to an alteration in taste, e.g. metallic aftertaste, in the food product, preferably bakery or patisserie product.

Accordingly, a first aspect of the present invention provides a powdered sugar replacer comprising, consisting essentially of, or consisting of:
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% of one or more starch product(s), and
optionally one or more enzyme(s) and/or one or more reducing agent(s).

In other words, in particular embodiments, the powdered sugar replacer is a clean label powdered sugar replacer. In the context of the present invention the term “clean label” is used for food products and food ingredients that comprise at most 0.010% (w/w), at most 0.005% (w/w), at most 0.002% (w/w), at most 0.001% (w/w), preferably no, artificial ingredients and/or synthetic chemicals. Non-limiting examples of artificial ingredients or synthetic chemicals include food additives coded by an E number by the European Union, more particularly by the European Food Safety Authority (EFSA). E numbers are known in the art and can be assessed on the homepage of the Food Standards Agency https://www.food.gov.uk/business-guidance/approved-additives-and-e-numbers. E numbers include colours (E100-E199): preservatives (E200-E299): antioxidants and acidity regulators (E300-E399); thickeners, stabilizers and emulsifiers (E400-E499): pH regulators and anti-caking agents (E500-E599); flavour enhancers (E600-E699): antibiotics (E700-E799): glazing agents, gases and sweeteners (E900-E999): and additional additives (E1100-1599). Similar definitions for or lists of artificial ingredients or synthetic chemicals have been established by other countries as well.

Further non-limiting examples of artificial ingredients and/or synthetic chemicals include polydextrose, which is a synthetic polymer of glucose and is coded by E number E1200.

In the context of the present invention the term “modified starch” comprises any substance created by modification of starch. Preferably the modification is a non-chemical modification, such as a physical modification or an enzymatic modification (e.g. hydrolysis) or a combination thereof. Non-chemical modification of starch allows to obtain modified starch that is clean label. Modified starch may be obtained from wheat, maize, waxy maize, rice, potato and tapioca, preferably maize.

In particular embodiments, the one or more modified starches comprise, consist essentially of or consist of an oligosaccharide (i.e. comprising from 2 to 10 monosaccharides), a polysaccharide (e.g. comprising typically more than 10 monosaccharides, such as comprising about 100-200 monosaccharides), or a combination thereof.

In particular embodiments, the one or more modified starches are digestible modified starches.

In particular embodiments, the powdered sugar replacer does not comprise indigestible modified starches.

In particular embodiments, the one or more modified starch(es) comprise, consist essentially of or consist of maltotriose, maltotetraose, dextrin, maltodextrin, or a combination thereof. In more particular embodiments, the one or more modified starch(es) comprise, consist essentially of or consist of maltodextrin, preferably maize maltodextrin.

In particular embodiments, the oligosaccharide or polysaccharide has a dextrose equivalent (DE) from 1 to 40, from 5 to 40, from 10 to 40, from 5 to 30, from 10 to 30, from 15 to 30, or from 15 to 25, preferably from 10 to 30.

Preferably, the one or more modified starch(es) is maize maltodextrin with a DE between 16 and 20, even more preferably a clean label maltodextrin with a DE between 16 and 20.

In particular embodiments, the powdered sugar replacer as taught herein comprises between 20.0 and 80.0% w/w, between 30.0 and 80.0% w/w, preferably between 30.0 and 70.0% w/w; between 40.0 and 70.0% w/w; between 30.0 and 60.0% w/w, more preferably between 40.0 and 60.0% w/w, of one or more modified starch(es). The aforementioned amount of one or more modified starch(es) refers to the total amount of one or more modified starch(es) in the powdered sugar replacer and may originate from different sources.

The term “fructan” as used herein refers to oligomers and polymers of fructose molecules comprising a terminal molecule, such as a reducing molecule (e.g. glucose) or another residue, such as, for example, a steviol glycosyl residue or a mogrosyl residue, preferably a reducing molecule.

In particular embodiments, the one or more fructan(s) comprise, consist essentially of, or consist of inulin, fructo-oligosaccharide(s), or a combination thereof.

In particular embodiments, the one or more fructan(s) comprise, consist essentially of or consist of fructan derived from agave, wheat, onion, bananas, garlic, asparagus, Jerusalem artichoke, pea, chicory or a combination thereof, preferably chicory root. Preferably, the one or more fructan(s) in the powdered sugar replacer as taught herein is chicory root inulin or chicory root fructo-oligosaccharide(s). More preferably, the one or more fructan(s) in the powdered sugar replacer as taught herein are clean label. In particular embodiments, the powdered sugar replacer as taught herein comprises between 20.0 and 70.0% w/w; between 20.0 and 60.0% w/w, between 20.0 and 50.0% w/w, between 25.0 and 60.0% w/w preferably between 25.0 and 50.0% w/w, more preferably between 30.0and 40.0% w/w of one or more fructan(s). The aforementioned amount of one or more fructan(s) refers to the total amount of one or more fructan(s) in the powdered sugar replacer and may originate from different sources.

The one or more protein product(s) of the powdered sugar replacer as taught herein are selected from the group consisting of egg proteins, milk proteins, isolated cereal proteins (e.g. isolated wheat gluten), oilseed proteins, tuber proteins, root proteins and legume proteins (e.g. chickpea protein, lentil protein, faba bean protein, or soybean protein).

Preferably, the protein product(s) of the powdered sugar replacer as taught herein are selected from the group consisting of egg protein, cascin, whey protein, isolated cereal proteins, oilseeds protein, legume protein and any combination thereof. More preferably, the protein product of the powdered sugar replacer as taught herein is egg white protein.

In particular embodiments, the one or more protein product(s) selected from the group consisting of egg proteins, milk proteins, isolated cereal proteins, oilseed proteins, tuber proteins, root proteins and legume proteins in the powdered sugar replacer are clean label.

In some other embodiments, the one or more protein product(s) selected from the group consisting of egg proteins, milk proteins, isolated cereal proteins, oilseed proteins, tuber proteins, root proteins, and legume proteins are gel-forming proteins.

The term “gel-forming” as used herein refers to the ability of a molecule (e.g. a protein) to form a viscoelastic aggregate, particularly upon heating, also called a gel (i.e. gelling or gelation). A protein gel is a three-dimensional network in which polymer-polymer and polymer-solvent interactions occur in an ordered manner, resulting in the immobilization of large amounts of water by a small proportion of protein. A gel may be formed from proteins when partially unfolded proteins develop uncoiled polypeptide segments that interact at specific points to form a three dimensional such as a coagulum or a cross-linked network. Partial unfolding of proteins with slight changes in secondary structure is typically required for gelation. Partial unfolding of the native structure can be related to the action of various factors such as heating, treatment with enzymes, acids, alkali and/or urea. The protein may form a gel spontaneously or by heat-and/or enzyme-induction, preferably by heat-induction. The type of forces that hold a gel together will depend on the characteristics of the native protein. These include hydrophobic interaction, hydrogen bonding, electrostatic interaction, and/or disulfide cross-links. It is understood by the skilled person that gel-forming or gelling proteins as considered herein can easily be distinguished from non-gelling proteins by measuring the changes in rheological properties during heating, such as during heating from 20° C. to 95° C., from 30°° C. to 95° C. or from 40°° C. to 95° C., such as from 50° C. to 90° C. or from 50°° C. to 95° C., at a heating rate between 0.5 and 10° C./min.

In particular embodiments, a protein product is considered to be gel-forming when the viscosity of a 12.0% (w/w) protein solution/dispersion in water increases by 100.0% during a temperature increase from 50.0 to 95.0°° C. performed over 7.5 minutes, and/or during a subsequent holding phase of 5 min at 95° C., when measured with a Rapid Visco Analyzer (Perkin-Elmer). In such an analysis the viscosity of a non-gelling protein solution will (essentially) not increase with the temperature increase.

In some embodiments, the one or more protein product(s) selected from the group consisting of egg proteins, milk proteins, isolated cercal proteins, oilseed proteins, tuber proteins, root proteins, and legume proteins are protein-rich fractions derived from a plant or animal source, i.e. the protein concentration in the protein product used in the powdered sugar replacer is higher than in the plant or animal source from which the protein product is derived. Preferably, the one or more protein product(s) comprise at least 30.0% (w/w dry matter), or at least 40.0% (w/w dry matter), preferably at least 50.0% (w/w dry matter), or at least 60.0% (w/w dry matter), more preferably at least 70.0% (w/w dry matter), of proteins.

In some embodiments, in particular if the one or more protein product(s) comprise non-egg proteins, the one or more protein product(s) may be subjected to a limited hydrolysis, e.g. enzymatic hydrolysis. In some embodiments, the one or more protein product(s) selected from the group consisting of egg proteins, milk proteins, isolated cereal proteins, oilseed proteins, tuber proteins, root proteins, and legume proteins may be enzymatically modified, e.g. with a cross-linking enzyme such as transglutaminase or with another protein modifying enzyme such as a peptidyl or protein-glutaminasc.

In some embodiments, the one or more protein product(s) selected from the group consisting of egg proteins, milk proteins, isolated cereal proteins, oilseed proteins, tuber proteins, root proteins, and legume proteins may be hydrolysed and enzymatically modified, or may be enzymatically modified, but not hydrolysed.

In some embodiments the one or more protein product(s) selected from the group consisting of egg proteins, milk proteins, isolated cereal proteins, oilseed proteins, tuber proteins, root proteins, and legume proteins may be physically or chemically modified, e.g. through heat treatment and/or deamidation.

In particular embodiments, the powdered sugar replacer as taught herein comprises between 0.50 and 10.0% w/w, preferably between 1.0 and 8.0% w/w, more preferably between 1.0 and 5.0% w/w of one or more protein product(s) selected from the group consisting of egg proteins, milk proteins, isolated cereal proteins, oilseed proteins, tuber proteins, root proteins, and legume proteins. The afore-mentioned amount of one or more protein product(s) selected from the group consisting of egg proteins, milk proteins, isolated cereal proteins, oilseed proteins, tuber proteins, root proteins, and legume proteins. refers to the total amount of one or more one or more protein product(s) selected from the group consisting of egg proteins, milk proteins, isolated cereal proteins, oilseed proteins, tuber proteins, root proteins, and legume proteins in the powdered sugar replacer and may originate from different sources.

In some embodiments, in particular if the one or more protein product(s) comprise non-egg proteins, the one or more protein product(s) selected from the group consisting of egg proteins, milk proteins, isolated cereal proteins, oilseed proteins, tuber proteins, root proteins, and legume proteins are present in the powdered sugar replacer as taught herein in addition to any other protein originating from other ingredients of the powdered sugar replacer.

The term “starch product” as used herein refers to any source of unmodified or native starch, i.e. starch that has kept its original structure as it has in the plant from which it is derived. Accordingly, the starch product does not comprise modified starch(es). In particular embodiments, the starch product has not been modified by chemical, physical and/or enzymatical treatment. The starch product may comprise, consist essentially of or consist of non-purified, semi-purified, purified starch or any combination thereof. Suitable starch product(s) may be obtained from wheat, maize, waxy maize, rice, tapioca, potato, oat, rye, buckwheat, quinoa, soy, legumes, or a combination thereof. Preferably, the starch product(s) are obtained from maize, waxy maize, rice, tapioca, potato, oat, rye, buckwheat, quinoa, soy, legumes or a combination thereof. More preferably the starch product(s) comprises, consists essentially of, or consists of rice flour, tapioca starch or a combination thereof.

In particular embodiments, the powdered sugar replacer as taught herein comprises between 0.50 and 20.0% w/w, between 1.0 and 20.0%, preferably between 1.0 and 15.0% or between 1.0 and 10.0%,, more preferably between 2.0 and 10.0% of one or more starch product(s). In some embodiments, between 0.50 and 20.0% w/w, between 1.0 and 20.0% w/w, preferably between 1.0 and 15.0% w/w or between 1.0 and 10.0% w/w, more preferably between 2.0 and 10.0% w/w of one or more starch product(s) also encompass any other starch originating from other ingredients of the powdered sugar replacer.

In particular embodiments, the one or more enzymes are selected from the group consisting of amylases, maltogenic amylases, maltotriose-forming amylases, maltotetraose-forming amylases, peptidases, xylanases, lipases, phospholipases, transglutaminases, glucose oxidases, carbohydrate oxidases, hexose oxidases, lipoxygenases, inulinases and any combination thereof. Preferably, the one or more enzymes are selected from the group consisting of maltotetraose-forming amylases, maltogenic amylases, (phospho) lipases and any combination thereof. Preferably, the one or more enzymes are selected from the group consisting of maltotetraose-forming amylases, maltogenic amylases, phospholipases, lipases and any combination thereof.

The term “reducing agent” as used herein refers to a compound able to add hydrogen atoms to reactive sites of molecules. Examples of suitable reducing agents are glutathione, cysteine, and inactivated yeast (also termed inactive yeast, deactivated yeast, or yeast autolysate). Preferably, the reducing agent comprises, consists essentially of, or consists of inactivated yeast.

In particular embodiments, the powdered sugar replacer as taught herein comprises between 0.10 and 10.0% w/w, preferably between 0.20 and 5.0% w/w; more preferably between 0.30 and 2.50% w/w, of the one or more reducing agent(s).

In particular embodiments, the powdered sugar replacer does not comprise any ingredients in addition to the one or more modified starch(es), the one or more fructan(s), the one or more protein product(s) selected from the group consisting of egg proteins, milk proteins, isolated cereal proteins, oilseed proteins, tuber proteins, root proteins, and legume proteins, the one or more starch product(s), and optionally the one or more enzyme(s) and/or the one or more reducing agent(s).

A further aspect provides a method for preparing a powdered sugar replacer, such as the powdered sugar replacer as taught herein, comprising the steps of adding together, in any particular order, all ingredients of the powdered sugar replacer as taught herein.

In particular embodiments, the method comprises preparing a mixture, in any particular order, of at least
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% (w/w) of one or more starch product(s), and
optionally one or more enzyme(s) and/or one or more reducing agent(s).

In particular embodiments, all ingredients are included into the mixture as a dry powder.

A further aspect of the invention provides a cake mix or cake premix comprising the powdered sugar replacer as taught herein. Preferably, said cake mix or cake premix is suitable to prepare the cake batter and/or the cake product as taught herein.

The term “cake” as used herein refers to a batter-based baked product containing as main ingredients (wheat) flour, sugar (if part of the recipe and if not replaced by the sugar replacer as taught herein), fat and eggs or egg products. Depending on the type of cake, the ratio of flour, sugar and eggs or egg products will vary. Cakes may be acrated due to addition of ingredients (e.g. baking powder, egg, emulsifier, protein, etc.) and/or due to the cake preparation process (e.g. whipping of the batter). In the context of the present invention a cake product may be any cake product known in the art. Non-limiting examples of cakes are loaf cream and pound cakes, cup cream and pound cakes, sponge cakes, muffins, cake donuts and brownies.

Typically a cake mix comprises all the ingredients of a cake recipe with the exception of water, fat (oil, butter, margarine) and eggs or egg products, or all the ingredient of a cake recipe with the exception of water and fat (oil, butter, margarine) or even all the ingredients of a cake recipe with the exception of water. Typically a cake premix is a cake mix where all or part of the flour and sugar (if part of the recipe and if not replaced by the sugar replacer as taught herein) has been removed. Accordingly, the skilled person will understand that the addition of liquid (e.g. water, milk and/or liquid eggs), flour and/or sugar (if part of the recipe and if not replaced by the sugar replacer as taught herein) to the cake premix may allow obtaining a cake batter as described herein. The skilled person will also understand that the milk and/or the eggs may be present in the cake mix or in the cake premix under powdered form.

In particular embodiments, the cake mix or cake premix further comprises fat: dehydrated eggs or egg products: sugar or sweetener(s); leavening agent, and/or emulsifier(s). Preferably, the cake mix or cake premix does not comprise a sweetening agent, such as sugar and/or sweetener(s).

In particular embodiments, the cake mix or cake premix may further comprise one or more aroma components, flavour components, hydrocolloids (e.g. locust bean gum, guar gum, tara gum, xanthan gum, carrageenan, acacia gum, cellulose, modified cellulose and pectin), fibers (e.g. citrus fibers, cercal fibers), reducing agents (e.g. cysteine or glutathione), oxidants, yeast extract, enzyme active soy flour, starches (e.g. native, chemically and/or physically modified), cocoa powder, chocolate, colouring agents, milk powder, and/or enzymes.

A further aspect provides the use of the powdered sugar replacer as taught herein in a cake mix or cake premix.

A further aspect provides a method for preparing a cake mix or cake premix comprising the steps of adding the powdered sugar replacer as taught herein to one or more of the following cake mix or cake premix ingredients: fat: dehydrated eggs or egg products: sugar or sweetener(s): leavening agent, and/or emulsifier(s). In particular embodiments, the order in which the ingredients of the cake mix or cake premix as described herein are combined into a mixture may happen without method (i.e. at random).

It is another embodiment of the present invention to provide a dough or batter product, preferably a batter, that comprises the sugar replacer as taught herein. The dough or batter product may be any dough or batter product suitable for preparing a bakery or patisserie product, such as described elsewhere in the present specification. The sugar replacer as taught herein may replace in a dough or batter the conventionally added sugars or polyols, at any level, preferably between 10.0 and 100.0% (w/w). Preferably the substitution is one to one on a weight basis.

Accordingly, a further aspect provides a dough or batter product comprising the sugar replacer as taught herein or the cake mix or cake premix as taught herein.

In particular embodiments, the dough or batter product comprises:
between 3.0 and 22.0% (w/w), preferably between 10.0 and 20.0% (w/w) of one or more modified starch(es),
between 3.0 and 18.0% (w/w), preferably between 3.0 and 15.0% (w/w) of one or more fructan(s),
between 0.20 and 3.0% (w/w), preferably between 0.20 and 2.0% (w/w) of one or more protein product(s) selected from the group consisting of egg proteins, milk proteins, isolated cereal proteins, oilseed proteins, tuber proteins, root proteins, and legume proteins (i.e. in addition to any protein product(s) selected from the group consisting of egg proteins, milk proteins, isolated cereal proteins, oilseed proteins, tuber proteins, root proteins, and legume proteins present in the flour and/or eggs or egg products),
between 0.20 and 5.0%, preferably between 0.50 and 3.0% (w/w) of one or more starch product(s) (i.e. in addition to any starch product(s) present in the flour), and
up to 100% of one or more of flour, eggs or egg products, water, leavening agent, fat, and sweetening agent (in addition to the sugar replacer as taught herein).

In particular embodiments, the dough or batter product as taught herein comprises at most 90.0% (w/w), at most 80.0% (w/w), at most 70.0% (w/w), at most 60.0% (w/w), at most 50.0% (w/w), at most 40.0% (w/w), at most 30.0% (w/w), at most 20.0% (w/w), at most 10.0% (w/w), at most 5.0% (w/w) of the total amount of added sugar and/or polyol(s) present in a regular food product recipe, such as a regular bakery or patisserie product recipe, preferably a regular cake recipe.

For example, if a regular cake recipe comprises about 25.0% w/w of sugar, the sugar replacers as taught herein may replace all of said sugar, resulting in a cake recipe not comprising any sugar or polyols. Accordingly, in particular embodiments, the dough or batter product as taught herein comprises no added sugars or polyols. In the context of the present invention the term “added sugars and/or polyol(s)” is used to designate the sugars and/or polyols, with the exception of glycerol, that are present in a regular food product recipe, such as a regular bakery or patisserie product recipe, preferably a regular cake recipe. The term “added sugars and/or polyol(s)” as used herein also refers to monosaccharides (e.g. glucose, fructose, dextrose), disaccharides (e.g. sucrose, maltose, lactose) and their derived polyols (e.g. sorbitol, maltitol) or combinations thereof.

In particular embodiments, the dough or batter product as taught herein comprises no added sweetening agent (i.e. a sweetening agent in addition to the powdered sugar replacer as taught herein).

The dough or batter product may be of any type corresponding to the desired type of product. Non-limiting examples of batters are batters for preparation of sponge cakes, chiffon cakes, cream cakes, moist cakes, castella cakes, egg-free cakes, (steamed) cake donuts, muffins, cupcakes, loaf cakes, layer cakes, cookies, biscuits and variations thereof. Preferred batters are cake batters for sponge cakes and cream cakes.

A regular cake batter product typically comprises between 10.0 and 30.0% (w/w), preferably between 20.0 and 30.0% (w/w) of a sugar and/or polyols.

Accordingly, as the powdered sugar replacer as taught herein can be used on a 1:1 weight basis to replace sugars and/or polyols, in particular embodiment, the cake batter product may comprise between 10.0 and 30.0% (w/w), preferably between 15.0 and 30.0% (w/w) of the powdered sugar replacer as taught herein or a combination of a sweetening agent (preferably sugar and/or polyols) and the powdered sugar replacer as taught herein.

Although the types and amounts of ingredients of a cake batter may vary depending of the desired cake type most of the cake batters as taught herein contain flour, eggs or egg products, sweetening agent and optionally fat.

Accordingly, in particular embodiments, the cake batter, comprises, consists essentially of, or consists of:
flour,
eggs or egg products,
sugar replacer as taught herein,
optionally leavening agent,
optionally fat, and
optionally sweetening agent.

In particular embodiments, the dough or batter as taught herein comprises a leavening agent, fat, or a combination thereof.

In particular embodiments, the dough or batter product as taught herein comprises less added sweetening agent than a regular cake batter of the same type.

In particular embodiments, the powdered sugar replacer as taught herein is used on a 1 to 1 basis (w/w) to substitute the sweetening agent, preferably sugar and/or polyols, conventionally used in the dough or batter recipe, such as a cake batter recipe. The person skilled in the art will understand that, in certain embodiments, such as when replacing a particular high-intensity sweetener by the powdered sugar replacer as taught herein, a 1 to 1 (w/w) basis may not apply.

In another preferred embodiment, the powdered sugar replacer as taught herein replaces in a regular dough or batter composition, preferably a cake batter composition, between 10.0 and 100.0% (w/w), preferably between 20.0 and 100.0% (w/w), more preferably between 30.0 and 100.0% (w/w), even more preferably between 70.0 and 100.0% (w/w) or up to 100.0% (w/w) of the sweetening agent, preferably of the sugar and/or polyols. Preferably, the dough or batter as taught herein, preferably the cake batter, does not comprise added sweetening agent (i.e. a sweetening agent in addition to the powdered sugar replacer as taught herein).

In particular embodiments, the cake batter as taught herein is a cream type cake batter comprising, consisting essentially of, or consisting of:
between 15.0 and 30.0% (w/w), preferably between 20.0 and 30.0% (w/w), of flour, such as wheat flour,
between 5.0 and 30.0% (w/w), preferably between 10.0 and 25.0% (w/w), of fat,
between 7.0 and 25.0% (w/w), preferably between 10.0 and 25.0% (w/w), of eggs or egg products,
between 3.0 and 22.0% (w/w), preferably between 10.0 and 20.0% (w/w) of one or more modified starch(es),
between 3.0 and 18.0% (w/w), preferably between 3.0 and 15.0% (w/w) of one or more fructan(s),
between 0.20 and 3.0% (w/w), preferably between 0.20 and 2.0% (w/w) of one or more protein product(s) selected from the group consisting of egg proteins, milk proteins, isolated cereal proteins, oilseed proteins, tuber proteins, root proteins, and legume proteins in addition to any protein product(s) selected from the group consisting of egg proteins, milk proteins, isolated cereal proteins, oilseed proteins, tuber proteins, root proteins, and legume proteins present in the flour and/or eggs or egg products,
between 0.20 and 5.0%, preferably between 0.50 and 3.0% (w/w) of one or more starch product(s) in addition to any starch product(s) present in the flour (e.g. between 0.20 and 5.0%, preferably between 0.50 and 3.0% (w/w) of wheat starch in addition to any wheat starch present in wheat flour),
optionally one or more enzyme(s),
optionally one or more reducing agent(s), and water up to 100.0%.

As the flour of the cream type cake batter recipe may comprise, for instance, legume proteins, and the eggs or egg products may comprise egg proteins, the total amount of one or more protein product(s) selected from the group consisting of egg proteins, milk proteins, isolated cereal proteins, oilseed proteins, tuber proteins, root proteins, and legume proteins in the cream type cake batter may be between 0.20 and 11.4% (w/w), preferably between 0.20 and 10.4% (w/w).

As the flour of the cream type cake batter recipe may comprise, for instance, one or more starch products, the total amount of one or more starch products in the cream type cake batter may be between 0.20 and 30.0%, preferably between 0.50 and 28.0% (w/w).

Accordingly, in particular embodiments, the cake batter as taught herein is a cream type cake batter comprising, consisting essentially of, or consisting of:
between 15.0 and 30.0% (w/w), preferably between 20.0 and 30.0% (w/w), of flour, such as wheat flour,
between 5.0 and 30.0% (w/w), preferably between 10.0 and 25.0% (w/w), of fat,
between 7.0 and 25.0% (w/w), preferably between 10.0 and 25.0% (w/w), of eggs or egg products,
between 3.0 and 22.0% (w/w), preferably between 10.0 and 20.0% (w/w) of one or more modified starch(es),
between 3.0 and 18.0% (w/w), preferably between 3.0 and 15.0% (w/w) of one or more fructan(s),
between 0.20 and 11.4% (w/w), preferably between 0.20 and 10.4% (w/w) of one or more protein product(s) selected from the group consisting of egg proteins, milk proteins, isolated cereal proteins, oilseed proteins, tuber proteins, root proteins, and legume proteins,
between 0.20 and 30.0%, preferably between 0.50 and 28.0% (w/w) of one or more starch product(s),
optionally one or more enzyme(s),
optionally one or more reducing agent(s), and
water up to 100.0%.

In particular embodiments, the cream cake batter does not comprise added sweetening agent (i.e. a sweetening agent in addition to the powdered sugar replacer as taught herein).

In particular embodiments, the cake batter is a sponge type cake batter comprising, consisting essentially of, or consisting of:
between 7.0 and 30.0% (w/w), preferably between 20.0 and 30.0% (w/w), of flour, such as wheat flour,
between 10.0 and 45.0% (w liquid eggs/w), preferably between 35.0 and 45.0% (w liquid eggs/w) of eggs or egg products,
between 3.0 and 22.0% (w/w), preferably between 10.0 and 20.0% (w/w) of one or more modified starch(es),
between 3.0 and 18.0% (w/w), preferably between 3.0 and 15.0% (w/w) of one or more fructan(s),
between 0.20 and 3.0% (w/w), preferably between 0.20 and 2.0% (w/w) of one or more protein product(s) selected from the group consisting of egg proteins, milk proteins, isolated cereal proteins, oilseed proteins, tuber proteins, root proteins, and legume proteins in addition to any protein product(s) selected from the group consisting of egg proteins, milk proteins, isolated cereal proteins, oilseed proteins, tuber proteins, root proteins, and legume proteins present in the flour and/or eggs or egg products,
between 0.20 and 5.0%, preferably between 0.50 and 3.0% (w/w) of one or more starch product(s) in addition to any starch product(s) present in the flour,
optionally one or more enzyme(s),
optionally one or more reducing agent(s), and
water up to 100.0%.

As the flour of the sponge type cake batter recipe may comprise, for instance, legume proteins, and the eggs or egg products may comprise egg proteins, the total amount of one or more protein product(s) selected from the group consisting of egg proteins, milk proteins, isolated cereal proteins, oilseed proteins, tuber proteins, root proteins, and legume proteins in the sponge type cake batter may be between 0.20 and 13.9% (w/w), preferably between 0.20 and 12.9% (w/w).

As the flour of the sponge type cake batter recipe may comprise, for instance, one or more starch products, the total amount of one or more starch products in the sponge type cake batter may be between 0.20 and 30.0%, preferably between 0.50 and 28.0% (w/w).

Accordingly, in particular embodiments, the cake batter is a sponge type cake batter comprising, consisting essentially of, or consisting of:
between 7.0 and 30.0% (w/w), preferably between 20.0 and 30.0% (w/w), of flour, such as wheat flour,
between 10.0 and 45.0% (w liquid eggs/w), preferably between 35.0 and 45.0% (w liquid eggs/w) of eggs or egg products,
between 3.0 and 22.0% (w/w), preferably between 10.0 and 20.0% (w/w) of one or more modified starch(es),
between 3.0 and 18.0% (w/w), preferably between 3.0 and 15.0% (w/w) of one or more fructan(s), between 0.20 and 13.9% (w/w), preferably between 0.20 and 12.9% (w/w) of one or more protein product(s) selected from the group consisting of egg proteins, milk proteins, isolated cereal proteins, oilseed proteins, tuber proteins, root proteins, and legume proteins, between 0.20 and 30.0%, preferably between 0.50 and 28.0% (w/w) of one or more starch product(s),
optionally one or more enzyme(s),
optionally one or more reducing agent(s), and
water up to 100.0%.

In particular embodiments, the sponge cake batter does not comprise added sweetening agent (i.e. a sweetening agent in addition to the powdered sugar replacer as taught herein).

The term “flour” as used herein refers to any flour or mixture of flours suitable for preparing cakes. Examples of suitable flours are described in the chapter 2 “flour specification” of the book “The technology of cake making”, by E. B. Bennion and G. S. T. Bamford, 1997, Springer Science incorporated here by reference.

The term “fat” as used herein refers to fats that are liquid at room temperature (i.e. oils) and/or to fats that are solid at room temperature. The fat may be of animal and/or plant origin. The fat may be any suitable fat known in the art for preparing cakes. Non-limiting examples of suitable fats are vegetable oil (e.g. soy oil, sunflower oil, palm oil, canola oil), shortening (e.g. emulsified shortening or non-emulsified shortening), margarine, butter, powdered fat and fat paste.

The term “eggs or egg products” as used herein refers to fresh eggs (e.g. egg white, egg yolk, whole egg), liquid eggs, frozen eggs, powdered eggs (e.g. egg white powder, egg yolk powder, whole egg powder, egg albumin powder) or a combination thereof. The eggs or egg products may be pasteurized.

In particular embodiments, the eggs or egg products may be a combination of egg white powder and egg yolk powder.

The term “leavening agent” as used herein refers to one or more substances used in a dough or a batter that causes the lightening and the softening of the finished baked product. Formation of carbon dioxide is induced by chemical agents reacting with moisture, heat, acidity, or other triggers. The leavening agent in the batter of the present invention may be any leavening agent suitable for preparing cakes. The leavening agents as referred to herein are chemical compounds such as baking powder. Baking powder typically comprises a carbon dioxide carrier (typically a salt of bicarbonate) and a leavening acid (typically a low molecular weight (in) organic acid). Generally recognized inorganic leavening acids may include monocalcium phosphates (Ca (H₂PO₄)₂), sodium aluminium sulphate (NaAl (SO₄)₂.12H₂O), disodium pyrophosphate (Na₂H₂P₂O₇), and sodium aluminium phosphates (NaH₁₄Al; (PO₄)₈.4H₂O and Na: HisAl₂ (PO₄)₈). Generally recognized organic leavening acids may comprise citric acid, glucono delta-lactone, cream of tartar, tartaric acid, fumaric acid or lactic acid. Other leavening agents such as phosphate-free leavening agents may be used as well.

An alternative or supplement to the presence of a leavening agent in the dough or batter product, the dough or batter product may be mechanically leavened. During mechanical leavening air is incorporated into the dough or batter using mechanical means.

The term “sweetening agent” as used herein refers to any food-grade substance with a sweet taste or to any mixture thereof. The sweetening agent may be any sugar or derivative. Non-limiting examples of sweetening agents are monosaccharides (e.g. glucose, fructose, dextrose, galactose), disaccharides (e.g. sucrose, maltose, lactose) and their derived polyols (e.g. sorbitol, maltitol) or combinations thereof. In particular embodiments, the sweetening agent may be present in powdered form or as a syrup. The skilled person will understand that, when reducing the amount of (regular) sweetening agent in a cake recipe, the sweetness perception is (may be) reduced. It is possible to compensate this lack of sweetness in a cake by using, for example, low amounts of high-intensity sweeteners. Examples of high-intensity sweeteners (also referred to herein as “sweeteners”) are sucralose, aspartame or steviol glycosides.

In particular embodiments, the dough or batter product, preferably cake batter, may further comprise one or more emulsifiers. The term “emulsifier” as used herein refers to substances that are used in cake recipes to emulsify the lipid components (oil, shortening, margarine) into the water-phase of the cake batter, to facilitate and/or increase aeration of the batter during mixing and/or for the stabilization and/or the retention of air cells during baking. Non-limiting examples of emulsifiers typically used in cakes are mono-and diglycerides of fatty acids, lactic acid esters of mono-and diglycerides of fatty acids, acetic or lactic acid esters of mono-and diglycerides of fatty acids, diacetyl tartaric acid esters of mono-and diglycerides, polyglycerol monoesters of fatty acids, propylene glycol esters of fatty acid, sodium stearoyl lactylate, polysorbates, sucrose esters of fatty acids and lecithin (canola, soy, sunflower).

In particular embodiments, the dough or batter product, preferably cake batter, may further comprise one or more aroma components, flavour components, hydrocolloids (e.g. locust bean gum, guar gum, tara gum, xanthan gum, carrageenan, acacia gum, cellulose, modified cellulose and pectin), fibers (e.g. citrus fibers, cereal fibers), reducing agents (e.g. cysteine or glutathione), oxidants, yeast extract, enzyme active soy flour, starches (e.g. native, chemically and/or physically modified), cocoa powder, chocolate, colouring agents, and/or enzymes. The skilled artisan knows how to combine these ingredients to obtain the desired type of cake product.

In particular embodiments, the dough or batter product, preferably cake batter, may further comprise additional enzymes chosen from the group consisting of amylases, oxidases, proteases (peptidases), xylanases, lipases, phospholipases, transglutaminases and lipoxygenases. In particular embodiments, the dough or batter product comprises one or more enzymes in addition to the one or more enzymes present in the sugar replacer as taught herein.

In particular embodiments, the dough or batter product, preferably cake batter, may further comprise other non-chemical leavening agents, such yeast or sourdough.

A further aspect provides the use of the powdered sugar replacer as taught herein in a dough or batter product.

A further aspect provides a method for preparing a dough or batter product as taught herein, comprising the steps of adding the powdered sugar replacer as taught herein to flour, eggs or egg products, and optionally one or more of a leavening agent, fat and a sweetening agent.

In particular embodiments, the order in which the ingredients of the dough or batter product as described herein are combined into a mixture may happen without method (i.e. at random).

In particular embodiments, the ingredients of the powdered sugar replacer (i.e. the one or more modified starch(es), the one or more fructan(s), the one or more protein product(s) selected from the group consisting of egg proteins, milk proteins, isolated cereal proteins, oilseed proteins, tuber proteins, root proteins, and legume proteins, and the one or more starch product(s)) are mixed first into a mixture prior to mixing the powdered sugar replacer to the flour, eggs or egg products, and optionally one or more of a leavening agent, fat and a sweetening agent.

A further aspect provides a food product comprising the sugar replacer as taught herein. The food product may be any food product known in the art of which the regular recipe comprises a sweetening agent, preferably sugar and/or polyol(s).

A further aspect provides the use of the sugar replacer as taught herein in a food product.

A further aspect provides a method of preparing a food product comprising the sugar replacer as taught herein.

A further aspect provides a bakery or patisserie product prepared from the dough or batter product as taught herein.

Bakery and patisserie products include cake batters and cakes as described above as well as other products such as bread, soft rolls, bagels, donuts, Danish pastry, Chou pastry, Mochi breads, hamburger rolls, pizza, pita bread, ciabatta, sponge cakes, cream cakes, pound cakes, muffins, cupcakes, steamed cakes, waffles, brownies, cake donuts, yeast raised donuts, baguettes, rolls, crackers, cookies, biscuits, pie crusts, rusks. Preferably, said bakery or patisserie product is a cake, more preferably a cream cake or a sponge-type cake.

The cake or cake product can be defined by several texture parameters such as hardness, resilience, springiness, cohesiveness, chewiness and stickiness of the cake product.

The texture parameters may be evaluated by performing a Texture Profile Analysis (TPA) on a cake crumb sample obtained from the cake product or the whole (i.e. entire) cake product. The TPA may be performed with any system known by the skilled person to perform a TPA. For example, such a system may be a Texture Analyser (e.g. TAXT2i, Stable Micro Systems).

More particularly, the texture parameters such as hardness, resilience, springiness, cohesiveness, chewiness and stickiness of the cake product can be calculated from the force-time curve registered when performing a TPA on a cake sample using a Texture Analyser. In TPA, two consecutive deformations with a short waiting time in between the deformations are applied on a cake crumb sample and the force registered by the load cell of the texture analyser is measured as a function of time. For example, two consecutive deformations of a cylindrical cake crumb sample (e.g. with a diameter of 45 mm and a height of 40 mm) with a cylindrical probe (e.g. with a diameter of 100 mm) with a maximum deformation of 50% of the initial height of the product may be performed at a deformation speed of 2 mm/s and a waiting time between the two consecutive deformations of 3s. The force needed to deform the sample may be recorded as a function of time (i.e. force-time curve).

A value of 100 may be set for the respective texture parameters of a cake crumb sample that is used as reference sample in a given test (e.g. a cake crumb sample of a cake product prepared from cake batter comprising sugar and/or polyol(s) instead of the sugar replacer as described herein). The parameter values of cake crumb samples different from said reference sample may be expressed relative to this reference sample.

The term “hardness” as used herein refers to the maximal force needed to apply a defined deformation (e.g. a fixed deformation of 50% of the initial height of the cake crumb sample or the whole cake product) to a cake crumb sample of the cake product or the whole cake product. The term “hardness” may also refer to the sense related to the force required to compress the cake crumb sample or the whole cake product.

The term “resilience” as used herein refers to the speed (and degree) at which a cake crumb sample of the cake product or the whole cake product returns to its original shape after a certain deformation. It is a measure for how well a product “fights to regain its original height” after a deformation has been applied. Based on TPA method as described elsewhere herein, the resilience may be calculated as the ratio (in %) between the surface under the first deformation curve when the probe is moving upwards to the surface under the first deformation curve when the probe is moving downwards.

The term “springiness” as used herein refers to an expression of how well a cake product physically springs back after it has been deformed during the first compression of the TPA method as described elsewhere herein and has been allowed to wait for the target wait time between deformations. The springiness may be calculated as the height (in %) of the cake crumb sample after the first deformation and 3 sec of rest compared to the initial height of the cake crumb sample.

The term “cohesiveness” as used herein refers to the degree to which the cake crumb of the cake product holds together when rubbing or folding. Based on the TPA method as described elsewhere herein, the cohesiveness may be calculated as the ratio (expressed in %) between the surface under the second deformation curve (i.e. downwards and upwards) and the ratio under the first deformation curve (i.e. downwards and upwards).

The term “stickiness” as used herein refers to the negative force needed to loosen the probe from the cake surface after cake deformation.

Alternatively, certain cake texture parameters may also be evaluated by performing a sensorial analysis using a panel of cake experts. The cake experts are cake consumers that have been trained to describe and score the different cake texture properties that describe cake freshness: softness (i.e. opposite of hardness), moistness and cohesiveness, all individually and independently.

In particular embodiments, such as wherein the powdered sugar replacer as taught herein replaces all the sugar and/or polyol(s) in a regular cake recipe, the cake product comprises the same or highly similar textural properties as the regular cake product (i.e. comprising sugar and/or polyol(s)).

In particular embodiments,
the volume of the cake product as taught herein is at most 15.0%, at most 10.0%, or at most 5.0% higher or lower than the volume of a reference cake product, wherein said reference cake product is a cake product prepared using a sweetening agent, such as sugar and/or polyol(s), instead of the powdered sugar replacer as taught herein:
the hardness of the cake product as taught herein is at most 15.0%, at most 10.0%, or at most 5.0% higher or lower than the hardness of a reference cake product, wherein said reference cake product is a cake product prepared using a sweetening agent, such as sugar and/or polyol(s), instead of the powdered sugar replacer as taught herein:
the cohesiveness of the cake product as taught herein is at most 15.0%, at most 10.0%, or at most 5.0% higher or lower than the cohesiveness of a reference cake product, wherein said reference cake product is a cake product prepared using a sweetening agent, such as sugar and/or polyol(s), instead of the powdered sugar replacer as taught herein:
the resilience of the cake product as taught herein is at most 15.0%, at most 10.0%, or at most 5.0% higher or lower than the resilience of a reference cake product, wherein said reference cake product is a cake product prepared using a sweetening agent, such as sugar and/or polyol(s), instead of the powdered sugar replacer as taught herein:
the springiness of the cake product as taught herein is at most 15.0%, at most 10.0%, or at most 5.0% higher or lower than the springiness of a reference cake product, wherein said reference cake product is a cake product prepared using a sweetening agent, such as sugar and/or polyol(s), instead of the powdered sugar replacer as taught herein: and/or
the stickiness of the cake product as taught herein is at most 15.0%, at most 10.0%, or at most 5.0% higher or lower than the stickiness of a reference cake product, wherein said reference cake product is a cake product prepared using a sweetening agent, such as sugar and/or polyol(s), instead of the powdered sugar replacer as taught herein.

In particular embodiments, the cake product has a shelf-life of at least 24 hours, at least 48 hours, at least 1 week, preferably at least 2 weeks. In particular embodiments, the shelf-life of the cake product as taught herein is equal to or very similar to the shelf-life of a reference cake product, wherein said reference cake product is a cake product prepared using a sweetening agent, such as sugar and/or polyol(s), instead of the powdered sugar replacer as taught herein.

A further aspect provides the use of the powdered sugar replacer as taught herein for improving the health properties of a food product, preferably a bakery or patisserie product, more preferably a cake product, while maintaining the textural properties (e.g. volume, hardness, cohesiveness, resilience, springiness, and/or stickiness) of said food product.

A further aspect provides a method of preparing a bakery or patisserie product as taught herein, comprising preparing a dough or batter product by mixing the powdered sugar replacer as taught herein to flour, eggs or egg products, and optionally one or more of a leavening agent, fat and a sweetening agent (other than the sugar replacer as taught herein), and baking the dough or batter product, thereby obtaining the bakery or patisserie product.

In a further aspect the present invention provides a method for preparing a cake, said method comprising
preparing a cake batter by mixing cake batter ingredients, said ingredients comprising powdered sugar replacer as taught herein and
baking the cake batter to make the cake.

In a preferred embodiment, the powdered sugar replacer as taught herein is used on a 1 to 1 basis (w/w) to substitute the conventionally used sweetening agent.

In another preferred embodiment, the powdered sugar replacer as taught herein replaces in a regular cake between 10.0 and 100.0% (w/w), preferably between 20.0 and 100.0% (w/w), more preferably between 30.0 and 100.0% (w/w), even more preferably between 70.0 and 100.0% (w/w) or up to 100.0% (w/w) of the sweetening agent. Preferably the cake on the present invention does not comprise added sweetening agent.

It is a particular advantage of the present invention that the batter and cakes prepared according to the method of the invention using the powdered sugar replacer as taught herein can be prepared in an existing (semi-) industrial or artisanal environment. No adaptations to the batter preparation or the baking processes are required.

In a further aspect the present invention provides a cake batter and/or a cake obtained by the methods of the invention. The cakes batters and the cakes obtained according to the methods of the present invention comprise, in contrast to the counterparts prepared with conventionally used sweetening agents, less or no added sweetening agents without requiring additional additive labelling (such as additional E-numbers), if the sugar replacer as taught herein is clean label, and/or without negatively impacting quality aspects, e.g. volume, structure or texture of the baked product. The cake (and its corresponding cake batter) may be of any type. Non-limiting examples of cake are sponge cakes, chiffon cakes, cream cakes, moist cakes, castella cakes, (steamed) donuts, muffins, cupcakes, loaf cakes, layer cakes and variations thereof. Preferred cakes are sponge cakes and cream cakes.

In a further aspect, the present invention relates to the use of the powdered sugar replacer as taught herein in food products, preferably in bakery and patisserie products whose regular recipe comprises one or more sweetening agent(s). Bakery and patisserie products include cake batters and cakes as described above as well as other products such as bread, soft rolls, bagels, donuts, Danish pastry, Chou pastry, Mochi breads, hamburger rolls, pizza, pita bread, ciabatta, sponge cakes, cream cakes, pound cakes, muffins, cupcakes, steamed cakes, waffles, brownies, cake donuts, yeast raised donuts, baguettes, rolls, crackers, cookies, biscuits, pie crusts, rusks.

Accordingly, in other words, a further aspect provides the use of a composition comprising:
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% of one or more starch product(s), and
optionally one or more enzyme(s) and/or one or more reducing agent(s) as a complete or partial replacement for one or more sweetening agents, preferably sugar and/or polyol(s), more preferably for sucrose, such as in a food product recipe, preferably a bakery or patisserie product recipe, more preferably a cake recipe.

In a preferred embodiment, the present invention provides the use of the powdered sugar replacer as taught herein to substitute on a 1 to 1 basis (w/w) the conventionally used sweetening agent, preferably sugar and/or polyol(s).

In another preferred embodiment, the powdered sugar replacer as taught herein is used to substitute in a regular cake batter composition between 10.0 and 100.0% (w/w), preferably between 20.0 and 100.0% (w/w), more preferably between 30.0 and 100.0% (w/w), even more preferably 100.0% (w/w) of the sweetening agent.

The person skilled in the art will understand that the particular embodiments of the products as taught herein are also applicable to the methods and uses as taught herein and vice versa.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as follows in the spirit and broad scope of the appended claims. The above aspects and embodiments are further supported by the following non-limiting examples.

### EXAMPLES

### Example 1: Cream Cakes

Cream cakes were prepared using the ingredients listed in Table 1.

TABLE 1
cream cake ingredients

| % (w/w) | C** | REF | 2 | 3 | 4 | 5 | 6 | 7 |
|---|---|---|---|---|---|---|---|---|
| Wheat flour | | 26.24 | 26.24 | 26.24 | 26.24 | 26.24 | 26.24 | 26.24 |
| Water | | 12.00 | 12.00 | 12.00 | 12.00 | 12.00 | 12.00 | 12.00 |
| Eggs | | 18.67 | 18.67 | 18.67 | 18.67 | 18.67 | 18.67 | 18.67 |
| Oil (rapeseed) | | 16.00 | 16.00 | 16.00 | 16.00 | 16.00 | 16.00 | 16.00 |
| Emulsifier | | 0.53 | 0.53 | 0.53 | 0.53 | 0.53 | 0.53 | 0.53 |
| Baking powder | | 0.69 | 0.69 | 0.69 | 0.69 | 0.69 | 0.69 | 0.69 |
| Whey powder | | 1.33 | 1.33 | 1.33 | 1.33 | 1.33 | 1.33 | 1.33 |
| Sucrose | X | 24.53 | | | | | | |
| D-maltitol | X | | 24.53 | | | | | |
| Allulose | X | | | 24.53 | | | | |
| Chicory root inulin | X | | | | 24.53 | | | 9.81 |
| Maize maltodextrin (DE 16- | X | | | | | 24.53 | | 14.72 |
| 19.9) | | | | | | | | |
| Rice flour | X | | | | | | 24.53 | |
| Egg white powder | X | | | | | | | |
| Enzyme combination * | X | | | | | | | |
| TOTAL | | 100.00 | 100.00 | 100.00 | 100.00 | 100.00 | 100.00 | 100.00 |

| % (w/w) | 8 | 9 | 10 | 11 | 12 | 13 | 14 |
|---|---|---|---|---|---|---|---|
| Wheat flour | 26.24 | 26.24 | 26.24 | 26.24 | 26.24 | 26.24 | 26.24 |
| Water | 12.00 | 12.00 | 12.00 | 12.00 | 12.00 | 12.00 | 12.00 |
| Eggs | 18.67 | 18.67 | 18.67 | 18.67 | 18.67 | 18.67 | 18.67 |
| Oil (rapeseed) | 16.00 | 16.00 | 16.00 | 16.00 | 16.00 | 16.00 | 16.00 |
| Emulsifier | 0.53 | 0.53 | 0.53 | 0.53 | 0.53 | 0.53 | 0.53 |
| Baking powder | 0.69 | 0.69 | 0.69 | 0.69 | 0.69 | 0.69 | 0.69 |
| Whey powder | 1.33 | 1.33 | 1.33 | 1.33 | 1.33 | 1.33 | 1.33 |
| Sucrose | | | | | | | 15.94 |
| D-maltitol | | | | | | | |
| Allulose | | | | | | | |
| Chicory root inulin | 22.08 | | 8.83 | 9.81 | 8.83 | 8.83 | 2.92 |
| Maize maltodextrin (DE 16- | | 22.08 | 14.72 | 13.19 | 14.19 | 13.19 | 4.61 |
| 19.9) | | | | | | | |
| Rice flour | 2.45 | 2.45 | 0.98 | | 0.98 | 0.98 | 0.52 |
| Egg white powder | | | | 0.53 | 0.53 | 0.53 | 0.19 |
| Enzyme combination * | | | | 1.00 | | 1.00 | 0.35 |
| TOTAL | 100.00 | 100.00 | 100.00 | 100.00 | 100.00 | 100.00 | 100.00 |

* contains maltogenic amylase and (phospho)lipase
**ingredients marked with a “X” were, if not alone, blended together before being added to the rest of the batter ingredients

### Process

mix all ingredients in one phase with a planetary mixer (Hobart type N50) using a paddle for 2 min at speed 1 and 2 min at speed 2.
bake the batter (300 gg/mould) in a deck oven for 50 min at 180° C.
after 2 hours, pack the cakes in plastic bags.

### Evaluation of the Cakes

Cake volume and texture parameters are measured 24 h after baking. The volume is measured by rapeseed displacement. Measurements are performed in duplicate. Hardness (as opposite of softness), cohesiveness, resilience and springiness of the cake crumb are evaluated by Texture Profile Analysis (TPA) of cake crumb samples with a Texture Analyser (TAXT2, Stable Micro Systems, UK). Two consecutive deformations of a cylindrical cake crumb sample (diameter=45 mm, height 40 mm) with a cylindrical probe (diameter=100 mm) with a maximum deformation of 50% of the initial height of the product are performed at a deformation speed of 2 mm/sec and a waiting time between the two consecutive deformations of 3 s. Force, measured by the load cell of the Texture Analyser, is recorded as a function of time. Measurements are performed in quadruplicate.

The hardness is the maximum force needed to apply a fixed deformation of 50% of the initial height of the cake sample.

The cohesiveness is calculated as the ratio (expressed in percentage) between the surface under the second deformation curve (downwards+upwards) and the ratio under the first deformation curve (downwards+upwards).

The resilience is calculated as the ratio (in percentage) between the surface under the first deformation curve when the probe is moving upwards to the surface under the first deformation curve when the probe is moving downwards.

The springiness is calculated as the height (in percentage) of the cake cylinder after the first deformation and 3 s of rest compared to the initial height of the cake cylinder.

The stickiness is the negative force needed to loosen the probe from the cake surface after the deformation.

Table 2 lists the cake volume and texture properties obtained 24 h after baking and expressed relative to the results of the reference cake (1) that are set to 100. Cake 6 did not build up and was impossible to evaluate.

TABLE 2

| | REF | 2 | 3 | 4 | 5 | 6 | 7 | 8 | 9 | 10 | 11 | 12 | 13 | 14 |
|---|---|---|---|---|---|---|---|---|---|---|---|---|---|---|
| Volume | 100 | 100 | 78 | 104 | 93 | nd | 98 | 98 | 89 | 96 | 113 | 98 | 106 | 104 |
| Hardness | 100 | 94 | 258 | 87 | 90 | nd | 79 | 131 | 138 | 82 | 66 | 101 | 102 | 98 |
| Cohesiveness | 100 | 87 | 103 | 84 | 73 | nd | 79 | 81 | 70 | 80 | 95 | 92 | 98 | 101 |
| Resilience | 100 | 76 | 136 | 73 | 66 | nd | 68 | 73 | 65 | 70 | 96 | 87 | 97 | 103 |
| Springiness | 100 | 91 | 106 | 84 | 76 | nd | 81 | 89 | 84 | 83 | 91 | 92 | 96 | 99 |

nd: not determined

Table 3 lists the cake texture properties of cake 13 obtained 14 days after baking and expressed relative to the results of the reference cake (1) that are set to 100.

TABLE 3

| | REF | 13 |
|---|---|---|
| Hardness | 100 | 102 |
| Cohesiveness | 100 | 101 |
| Resilience | 100 | 112 |
| Springiness | 100 | 99 |

The results show that, using the powdered sugar replacer as taught herein, it is possible to replace up to 100% of the sugar (e.g. sucrose) in a cream cake while keeping the same or highly similar textural properties after 24 h and 14 days after baking.

### Example 2: Sponge Cakes

Sponge cakes were prepared using the ingredients listed in Table 4.

TABLE 4

| % (w/w) | C** | REF | 2 |
|---|---|---|---|
| Wheat flour | | 26.04 | 26.04 |
| Eggs | | 40.54 | 40.54 |
| Water | | 5.41 | 5.41 |
| Emulsifier | | 4.31 | 4.31 |
| Baking powder | | 1.05 | 1.05 |
| Sucrose | | 22.65 | |
| Maize maltodextrin (DE 16-19.9) | X | | 13.03 |
| Chicory root inulin | X | | 8.15 |
| Tapioca starch | X | | 0.91 |
| egg white powder | X | | 0.54 |
| Enzyme combination * | X | | 0.02 |
| TOTAL | | 100.00 | 100.00 |

* maltogenic amylase, maltotetraose-forming amylase
**ingredients marked with a “X” were blended together before being added to the rest of the batter ingredients

### Process

mix all ingredients in one phase with a planetary mixer (Hobart type N50) using a whisk for 1 min at speed 1 and 4 min at speed 3,.
divide the cake batter in baking moulds (400 g batter/mould),
bake in a deck oven for 30 min at 180° C.,.
after 2 hours, pack the cakes in plastic bags.

### Evaluation of the Cake

The texture of the cakes was evaluated as in example 1.

Table 5 lists the cake volume and texture properties obtained 24 h after baking and expressed relative to the results of the reference cake (1) that are set to 100.

TABLE 5

| RESULTS | REF | 2 |
|---|---|---|
| Cohesiveness | 100 | 89 |
| Resilience | 100 | 91 |
| Springiness | 100 | 95 |

The results show that, using the powdered sugar replacer as taught herein, it is possible to replace up to 100% of the sugar (sucrose) in a sponge cake while keeping the same or highly similar textural properties.

### Example 3: Chiffon Cakes

Chiffon cakes were prepared using the ingredients listed in Table 6.

TABLE 6

| Grams | C** | REF | 2 | 3 |
|---|---|---|---|---|
| Tegral Chiffon w/o sugar | | 22.73 | 22.73 | |
| (Puratos, Belgium) * | | | | |
| Sucrose | | 18.94 | 12.31 | |
| Eggs | | 40.00 | 40.00 | 40.00 |
| Oil (rapeseed) | | 11.67 | 11.67 | 11.67 |
| Water | | 6.67 | 6.67 | 6.67 |
| Chicory root inulin | X | | 2.39 | 6.82 |
| egg white powder | X | | 0.14 | 0.41 |
| Maize maltodextrin (DE 16-19.9) | X | | 3.56 | 10.18 |
| Enzyme combination** | X | | 0.27 | 0.77 |
| Rice flour | X | | 0.27 | 0.76 |
| TOTAL | | 100.00 | 100.00 | 100.00 |

* cake mix containing chiffon cake ingredients without sugar, eggs and oil (wheat flour, raising agent, flavouring, . . . )
**contains maltogenic amylase and (phospho)lipase
**ingredients marked with a “X” were blended together before being added to the rest of the batter ingredients

### Process

mix all ingredients without oil with a planetary mixer (Hobart type N50) using a whisk for 5 min at speed 3. Add the oil and mix again for 1 min at speed 1.
bake the batter (475 g/mould) in a deck oven for 35 min at 180° C.
shock the mould on a table.
after 2 hours, pack the cakes in plastic bags.

### Evaluation of the Cakes

The texture of the cakes was evaluated as in example 1.

Table 7 lists the cake volume and texture properties obtained 24 h after baking and expressed relative to the results of the reference cake (1) that are set to 100.

TABLE 7

| | REF | 2 | 3 |
|---|---|---|---|
| Height | 100 | 99 | 102 |
| Cohesiveness | 100 | 99 | 96 |
| Resilience | 100 | 99 | 93 |
| Springiness | 100 | 100 | 106 |

### Example 4: Steamed Cake Donuts

Steamed cake donuts where prepared using the ingredients listed in table 8

TABLE 8

| Recipe | C*** | Control | 1 | 2 | 3 | 4 |
|---|---|---|---|---|---|---|
| Easy ACTI Steam Donut (Puratos, | | 350.00 | 350.00 | 350.00 | 350.00 | 350.00 |
| Belgium) w/o sugar* | | | | | | |
| Flour | | 225.00 | 225.00 | 225.00 | 225.00 | 225.00 |
| Eggs | | 176.00 | 176.00 | 176.00 | 176.00 | 176.00 |
| Oil | | 116.00 | 116.00 | 116.00 | 116.00 | 116.00 |
| Water | | 243.00 | 243.00 | 243.00 | 243.00 | 243.00 |
| Sugar | | 310.00 | 155.00 | 155.00 | 155.00 | 155.00 |
| Maltitol | | | 155.00 | | | |
| Inulin | X | | | 83.20 | 83.20 | 83.20 |
| Maize maltodextrin (DE 16-19.9) | X | | | 62.00 | 62.00 | 62.00 |
| egg white powder | X | | | 3.48 | 3.48 | 3.48 |
| enzyme combination ** | X | | | 0.32 | 0.32 | 0.32 |
| native wheat starch | X | | | 6.00 | | |
| Native tapioca starch | X | | | | 6.00 | |
| Rice flour | X | | | | | 6.00 |
| Total | | 1420.00 | 1420.00 | 1420.00 | 1420.00 | 1420.00 |

*steamed cake mix containing wheat flour, emulsifiers, raising agent, colouring agents, flavours, . . . wherein the sugar has been replaced by wheat flour.
** contains maltogenic amylase and (phospho)lipase
***ingredients marked with a “X” were blended together before being added to the rest of the batter ingredients

### Process

mix all ingredients with a planetary mixer (Hobart N50) using a paddle for 1 minute at slow speed and 2 minutes at medium speed.
deposit portions of 40-50 g donut batter using a piping bag in greased cake donut pans
steam bake in a Rational steam cabinet oven at 103° C. for 6 minutes.

### Evaluation of the Donuts

The characteristics of donut batter and the steamed donuts were evaluated by a panel of persons trained to evaluate steamed donuts. Results are presented in table 9.

TABLE 9

| | Control | 1 | 2 | 3 | 4 |
|---|---|---|---|---|---|
| Batter | normal, allows | slightly higher | same as control | same as control | same as control |
| viscosity | easy handling | than control | | | |
| Donut | regular and | same as control | same as control | same as control | same as control |
| volume | well developed | | | | |
| Donut | Good | more sticky | Slightly dryer | Slightly softer | same as control |
| Crumb | resilience and | than control | than control | than control | |
| | cohesiveness | | | | |
| Donut | pleasant | metallic after | same as control | same as control | same as control |
| taste | | taste | (no metallic | (no metallic | (no metallic |
| | | | after taste) | after taste) | after taste) |

The texture of the steamed donuts was further evaluated by a Texture Profile Analysis as described in example 1. Results are presented in table 10.

TABLE 10

| | Control | 1 | 2 | 3 | 4 |
|---|---|---|---|---|---|
| Cohesiveness | 100 | NA* | 97 | 99 | 100 |
| Resilience | 100 | NA | 95 | 100 | 101 |
| Springiness | 100 | NA | 101 | 103 | 100 |
| Stickiness | 100 | NA | 128 | 110 | 95 |

NA: not assessed

1. A powdered sugar replacer comprising:
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% (w/w) of one or more starch product(s), and
optionally one or more enzyme(s) and/or one or more reducing agent(s).

2. The sugar replacer according to claim 1, wherein the sugar replacer comprises at most 0.010% (w/w) of artificial ingredients and/or synthetic chemicals.

3. The sugar replacer according to claim 1, wherein the one or more protein product(s) are gel-forming proteins and/or have a protein content of at least 30.0% (w/w dry matter).

4. A cake mix or cake premix comprising the powdered sugar replacer according to claim 1.

5. A dough or batter product comprising the sugar replacer according to claim 1.

6. The dough or batter product according to claim 5, wherein the dough or batter product further comprises flour, eggs or egg products, and optionally one or more of a leavening agent, fat, and a sweetening agent.

7. The dough or batter product according to claim 5, wherein the dough or batter product is a cake batter.

8. The dough or batter product according to claim 7, wherein the cake batter is a cream type cake batter comprising
between 15.0 and 30.0% (w/w) of flour,
between 5.0 and 30.0% (w/w) of fat,
between 7.0 and 25.0% (w/w) of eggs or egg products,
between 3.0 and 22.0% (w/w) of one or more modified starch(es),
between 3.0 and 18.0% (w/w) of one or more fructan(s),
between 0.20 and 11.4% (w/w) of one or more protein product(s) selected from the group consisting of egg proteins, milk proteins, isolated cereal proteins, oilseed proteins, tuber proteins, root proteins, and legume proteins,
between 0.20 and 30.0% (w/w) of one or more starch product(s),
optionally one or more enzyme(s) and/or one or more reducing agent(s), and
water up to 100.0% (w/w).

9. The dough or batter product according to claim 7, wherein the cake batter is a sponge-type cake batter comprising
between 7.0 and 30.0% (w/w) of flour
between 10.0 and 45.0% (w liquid eggs/w) of eggs or egg products,
between 3.0 and 22.0% (w/w) of one or more modified starch(es),
between 3.0 and 18.0% (w/w) of one or more fructan(s),
between 0.20 and 13.9% (w/w) of one or more protein product(s) selected from the group consisting of egg proteins, milk proteins, isolated cereal proteins, oilseed proteins, tuber proteins, root proteins, and legume proteins,
between 0.20 and 30.0% (w/w) of one or more starch product(s),
optionally one or more enzyme(s) and/or one or more reducing agent(s), and
water up to 100.0% (w/w).

10. The dough or batter product according to claim 5, wherein the dough or batter product does not comprise a sweetening agent in addition to the powdered sugar replacer.

11. A food product comprising the powdered sugar replacer according to claim 1, preferably wherein said food product is a bakery or patisserie product, more preferably wherein said bakery or patisserie product is a cake, even more preferably a cream cake or a sponge-type cake.

12. A method of preparing a powdered sugar replacer comprising preparing a mixture of at least
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% (w/w) of one or more starch product(s), and
optionally one or more enzyme(s) and/or one or more reducing agent(s).

13. A method for preparing the dough or batter product according to claim 5 comprising the steps of adding the powdered sugar replacer to flour, eggs or egg products, and optionally one or more of a leavening agent, fat and a sweetening agent.

14. A method for preparing a bakery or patisserie product comprising preparing a dough or batter product by mixing the powdered sugar replacer according to claim 1 to flour, eggs or egg products, and optionally one or more of a leavening agent, fat and a sweetening agent, and baking the dough or batter product, thereby obtaining the bakery or patisserie product.

15. Use of a composition comprising:
between 20.0 and 80.0% (w/w) of one or more modified starch(es),
between 20.0 and 70.0% (w/w) of one or more fructan(s),
between 0.50 and 10.0% (w/w) of one or more protein product(s) selected from the group consisting of egg proteins, milk proteins, isolated cereal proteins, oilseed proteins, tuber proteins, root proteins, and legume proteins,
between 0.50 and 20.0% of one or more starch product(s), and
optionally one or more enzyme(s) and/or one or more reducing agent(s) as a complete or partial replacement for a sweetening agent.
